(19) United States
(12) Patent Application Publication
(10) Pub. No.: US 2011/0206365 A1
(43) Pub. Date: Aug. 25, 2011

(54) CAMERA SHUTTER DEVICE AND OPTICAL APPARATUS HAVING THE SAME

(75) Inventors: Kyoungho Yoo, Seoul (KR); Seungki Kim, Seoul (KR); Taehwan Kim, Seoul (KR)

(73) Assignee: LG Innotek Co., Ltd., Seoul (KR)

(21) Appl. No.: 13/032,266

(22) Filed: Feb. 22, 2011

(30) Foreign Application Priority Data
Feb. 22, 2010 (KR) 10-2010-0015791

(51) Int. Cl. G03B 9/08

(52) U.S. Cl. 396/463

(57) ABSTRACT

A camera shutter device and an optical apparatus having the same are disclosed, wherein the device includes a core including a first rod and a second rod, each arranged in parallel with the other, and one of which is wrapped by a coil, a first distal end formed at the first rod to generate an electromagnetic force line, and a second distal end formed at the second rod to generate an electromagnetic force line, a magnet arranged in opposition to the first and second distal ends to linearly and reciprocally move between the first and second distal ends, a slider for opening and closing a shutter blade in a case the magnet linearly and reciprocally moves between the first and second distal ends, wherein each area of the first and second distal ends is larger than each cross-sectional area of the first and second rods, such that miniaturization and thinning of the shutter device can be realized, and generation of trembling phenomenon can be prevented during an opening/shutting operation of the shutter blade.

### CROSS-REFERENCE TO RELATED APPLICATION

This application claims the benefit under 35 U.S.C. §119 of Korean Patent Application No. 10-2010-0015791, filed Feb. 22, 2010, which is hereby incorporated by reference in its entirety.

### BACKGROUND OF THE DISCLOSURE

1. Technical Field

The teachings in accordance with the exemplary embodiments of this disclosure relate generally to a camera shutter device opening and shutting a lens nozzle in an optical imaging device including a camera-embedded mobile device, and an optical apparatus having the same.

2. Background Art

Recently, as the number of pixels in a camera-embedded mobile device increases, an optical imaging device including the camera-embedded mobile device is diversified and high-graded that is capable of photographing high quality pictures. Therefore, the camera-embedded mobile device badly needs adoption of a shutter configured to open and shut a lens nozzle that is used in the general camera.

If the shutter is employed in the camera-embedded mobile device, it is possible to photograph an image of high quality over a camera-embedded mobile device deprived of a shutter, and a ground can be provided to enable an embedded camera to exhibit a performance of high resolution in a proper manner.

However, due to the fact a small mobile device is restricted by installation space and battery consumption, miniaturization of shutter device including a shutter and other elements used for operating the shutter, and reduction of driving power must be taken into consideration on the top priority.

That is, as the conventional shutter device has a disadvantageously large number of elements with a complicated operation structure, an installation space is unnecessarily used, and power transmission loss increases to increase the battery consumption.

Another disadvantage is that a plurality of gears is used and picture quality of captured image can be degraded due to a slow response speed of a shutter if a complicated link mechanism is employed, because the shutter device should have a high shutter speed capable of instantly opening and shutting light reflected from an object.

### BRIEF SUMMARY

An object of the present disclosure is to solve at least one or more of the above disadvantages and/or shortcomings in a whole or in part and to provide at least the advantages described hereinafter.

Therefore, the present disclosure provides a camera shutter device capable of being miniaturized, light-weighted and thinned.

The present disclosure also provides a camera shutter device capable of allowing shutter blades to stably perform an opening/shutting operation and increasing an opening/shutting speed of the shutter blades.

The present disclosure also provides an optical apparatus configured for compactness by miniaturizing and thinning a camera shutter device

Technical disadvantages and/or shortcomings to be solved by the present disclosure are not restricted to the above-mentioned, and any other technical problems not mentioned so far will be clearly appreciated from the following description by skilled in the art.

In one general aspect of the present disclosure, there is provided a camera shutter device, the device comprising: a core including a first rod and a second rod, each arranged in parallel with the other, and one of which is wrapped by a coil, a first distal end formed at the first rod to generate an electromagnetic force line, and a second distal end formed at the second rod to generate an electromagnetic force line; a magnet arranged in opposition to the first and second distal ends to linearly and reciprocally move between the first and second distal ends; a slider for opening and closing a shutter blade in a case the magnet linearly and reciprocally moves between the first and second distal ends, wherein each area of the first and second distal ends is larger than each cross-sectional area of the first and second rods.

Preferably, the core is fixed at a base and integrally connected by the first and second rods.

Preferably, the core is relatively inclined from the magnet at a predetermined angle.

Preferably, the first distal end is bent from a distal end of the first rod toward the second rod.

Preferably, the first distal end is such that a distance between an external side positioned at an outside and the magnet is shorter than a distance between an internal side positioned at an inside and the magnet.

Preferably, the second distal end is bent from a distal end of the second rod toward the first rod.

Preferably, the second distal end includes a plane unit distanced from the magnet at a predetermined space, and an inclination unit gradually distanced from the magnet.

Preferably, the shutter blade is formed at one side thereof with a hinge hole hinged to the base, and is formed at the other side with a shutter plate for opening and closing an optical permeation hole of the base.

Preferably, the shutter blade is formed with a slot into which a driving shaft formed at the slider is inserted.

In another general aspect of the present disclosure, there is provided an optical apparatus, the apparatus comprising: a camera including a main body, a display unit arranged at a front surface of the main body for displaying information, and a camera shutter device provided at the main body for capturing an image or a photograph, wherein the camera shutter device includes a core including a first rod and a second rod, each arranged in parallel with the other, and one of which is wrapped by a coil, a first distal end formed at the first rod to generate an electromagnetic force line, and a second distal end formed at the second rod to generate an electromagnetic force line; a magnet arranged in opposition to the first and second distal ends to linearly and reciprocally move between the first and second distal ends; a slider for opening and closing a shutter blade in a case the magnet linearly and reciprocally moves between the first and second distal ends, wherein each area of the first and second distal ends is larger than each cross-sectional area of the first and second rods.

### ADVANTAGEOUS EFFECTS

The camera shutter device and optical apparatus having the same according to the present disclosure has an advantageous effect in that miniaturization and thinning of the shutter device can be realized, and generation of trembling phenomenon can be prevented during an opening/shutting operation of the shutter blade.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a perspective view illustrating an optical apparatus according to an exemplary embodiment of the present disclosure;

FIG. 2 is a structural view illustrating a camera shutter device according to an exemplary embodiment of the present disclosure;

FIG. 3 is a perspective view illustrating a driving unit of a camera shutter device according to an exemplary embodiment of the present disclosure;

FIG. 4 is a partially enlarged view illustrating a driving unit of a camera shutter device according to an exemplary embodiment of the present disclosure;

FIGS. 5 and 6 are operation status views illustrating a camera shutter device according to an exemplary embodiment of the present disclosure; and

FIG. 7 is a graph illustrating an open/close position of a shutter blade of a camera shutter device according to an exemplary embodiment of the present disclosure.

### DETAILED DESCRIPTION

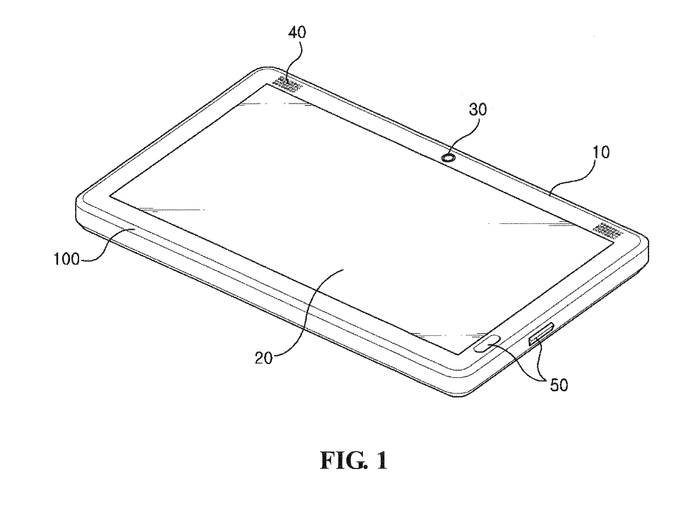

The disclosed embodiments and advantages thereof arc best understood by referring to FIGS. 1-7 of the drawings, like numerals being used for like and corresponding parts of the various drawings. Other features and advantages of the disclosed embodiments will be or will become apparent to one of ordinary skill in the art upon examination of the following figures and detailed description.

The exemplary embodiments described here in detail for illustrative purposes are subject to many variations in structure and design. It should be emphasized, however, that the present disclosure is not limited to a particular disclosure, as shown and described. It is understood that various omissions and substitutions of equivalents are contemplated as circumstances may suggest or render expedient, but these are intended to cover the application or implementation without departing from the spirit or scope of the claims of the present invention.

The terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item.

In describing the present disclosure, detailed descriptions of constructions or processes known in the art may be omitted to avoid obscuring appreciation of the invention by a person of ordinary skill in the art with unnecessary detail regarding such known constructions and functions. Accordingly, the meaning of specific terms or words used in the specification and claims should not be limited to the literal or commonly employed sense, but should be construed or may be different in accordance with the intention of a user or an operator and customary usages. Therefore, the definition of the specific terms or words should be based on the contents across the specification.

The limitations in the claims are to be interpreted broadly based the language employed in the claims and not limited to examples described in the present description or during the prosecution of the application, which examples are to be construed as non-exclusive. For example, in the present disclosure, the term “preferably”, “preferred” or the like is non-exclusive and means “preferably”, but not limited to.

It will be understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof That is, the terms “including”, “includes”, “having”, “has”, “with”, or variants thereof are used in the detailed description and/or the claims to denote non-exhaustive inclusion in a manner similar to the term “comprising”. Furthermore, “exemplary” is merely meant to mean an example, rather than the best.

FIG. 1 is a perspective view illustrating an optical apparatus according to an exemplary embodiment of the present disclosure.

The optical apparatus according to an exemplary embodiment of the present disclosure includes a main body (10), a display unit (20) arranged at a front surface of the main body (10) for displaying visual information or image information, a camera (30) mounted at one side of the main body (10) to capture an image or a photograph, a speaker (40) for outputting a sound, and an input unit (50) by which a user can input information.

The optical apparatus may be applied to any electronic apparatus mounted with a camera including, but not limited to, a laptop computer, a tablet PC, a mobile phone, a smart phone, a distal broadcasting terminal, a PDA (Personal Digital Assistant), a PMP (Portable Multimedia Player) and a navigation device. The camera (30) is mounted with a camera shutter device for opening/shutting a lens nozzle.

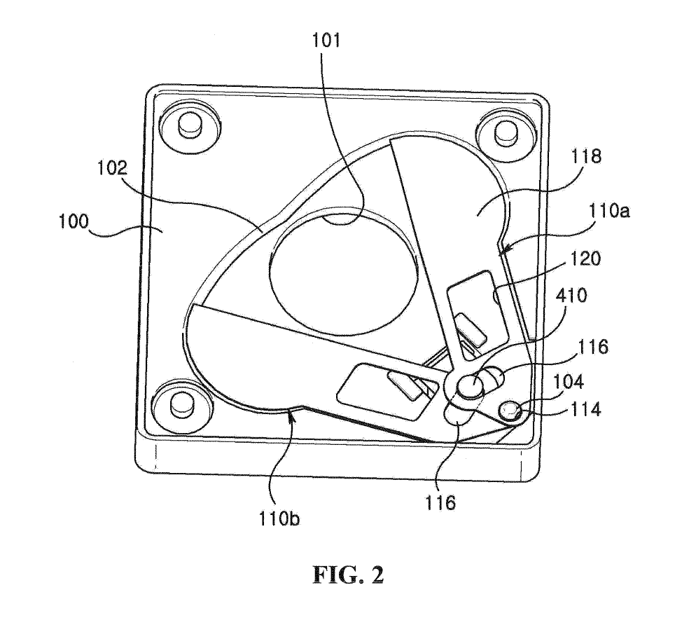

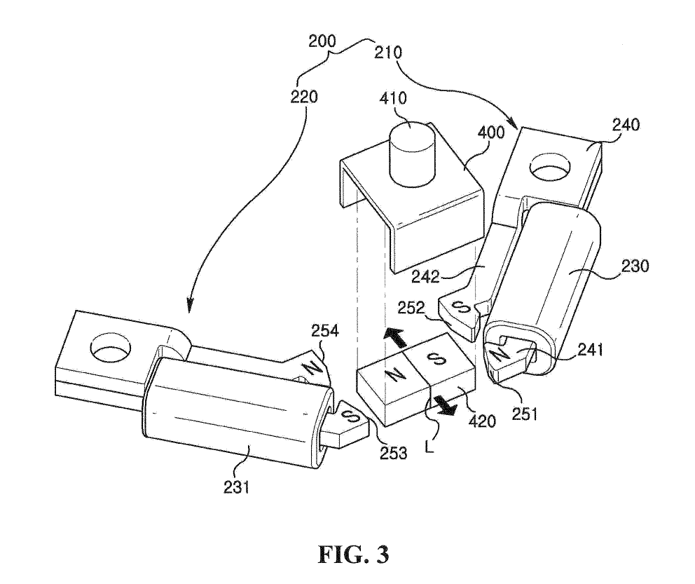

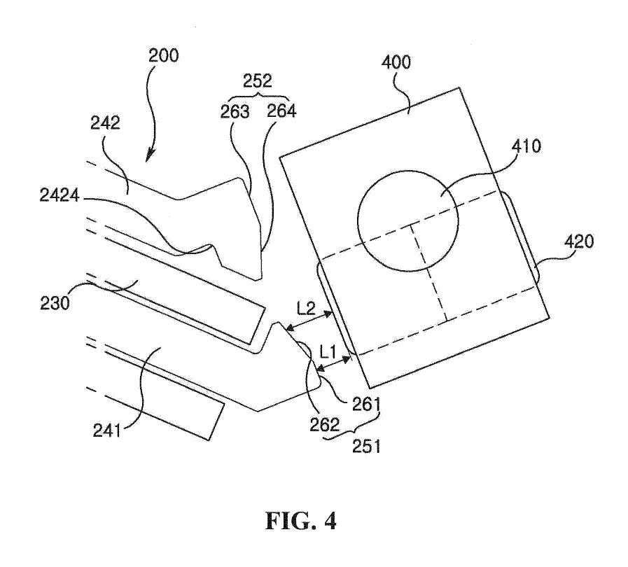

FIG. 2 is a structural view illustrating a camera shutter device according to an exemplary embodiment of the present disclosure, FIG. 3 is a perspective view illustrating a driving unit of a camera shutter device according to an exemplary embodiment of the present disclosure, and FIG. 4 is a partially enlarged view illustrating a driving unit of a camera shutter device according to an exemplary embodiment of the present disclosure.

Referring to FIGS. 2 and 4, configuration of a camera shutter device according to the present disclosure will be described in detail.

A shutter device according to an exemplary embodiment of the present disclosure includes a base (100) formed with a light permeation hole (101), a pair of shutter blades (110a, 110b) rotatably formed at the base for opening/shutting the light permeation hole (101), and a driving unit (500) for driving the pair of shutter blades (110a, 110b).

The base (100) is mounted on an optical image device, centrally formed with the light permeation hole (101) and formed with an accommodation unit (102) in which the pair of shutter blades (110a, 110b) is rotatably accommodated. The base (100) is formed at one side thereof with a hinge axis (104) on which the pair of shutter blades (110a, 110b) is hinged in an overlapped state.

The shutter blades (110a, 110b) are formed in a pair to shut the light permeation hole (101) to a mutually-wrapping direction, and to open the light permeation hole (101) by rotating to a mutually-separating direction.

The shutter blades (110a, 110b) are formed at one side thereof with a hinge hole (114) rotatably supported by the hinge axis (104), and are formed at the other side thereof with a semi-circular shutter plate (118) to open/shut the light permeation hole (101). The shutter blades (110a, 110b) arc also formed with a slot (116) that rotates the shutter plate (118) when a driving shaft (410) of the driving unit (500) is inserted to linearly and reciprocally move the driving axis (410).

The shutter blades (110a, 110b) are further folioed with a stopper hole (120) hinged by a stopper formed at the base (100) to restrict a rotation scope.

The slot (116) is formed at a place near the hinge hole (114) to minimize the linear reciprocating stroke of the driving axis (410), whereby the shutter blades (110a, 110b) can quickly perform the opening/shutting operation. Furthermore, the shutter blades (110a, 110b) can minimize the length of the slot (116) due to opening/shutting operation through linear reciprocating operation of the driving axis (410).

Referring to FIG. 3, the driving unit (500) includes a core (200), a coil (230) wrapped on the core (200) to magnetize the core (200) if a power is applied, a magnet (300) arranged in opposition to the core (200) to linearly move if the core (200) is magnetized, and a slider (400) fixed at the magnet (300) and formed with a driving axis (410).

The core (200) includes a fixture (240) fixed at the base (100), a first rod (241) extended from the first rod (240) and wrapped by a coil (230), and a second rod (242) extended from the fixture (240) and arranged in parallel with the first rod (241) at a predetermined space. At this time, the coil (230) may be wrapped on any one of the second rod (242) and the fixture (240) in addition to the first rod (241).

A first distal end (251) generating an electromagnetic force line of the first rod (241) and a second distal end (252) generating an electromagnetic force line of the second rod (242) have a mutually opposite polarity. For example, if a voltage of a forward direction is applied to the coil (230), the first distal end (251) is magnetized with S polarity, and the second distal end (252) is magnetized with N polarity. Alternatively, if a voltage of a reverse direction is applied to the coil (230), the first distal end (251) is magnetized with N polarity, and the second distal end (252) is magnetized with S polarity.

Each area of the first and second distal ends (251, 252) is larger than each cross-sectional area of the first and second rods (241, 242). That is, if an area of the distal end is equal to that of the rod, there may be an advantage of the electromagnetic force lines being densified, but there is a disadvantage in that an area for generating an electromagnetic force lines is narrowed to increase a difference of induced electromotive force, whereby a great force may be generated from the magnet when the magnet moves linearly and reciprocally to generate trembling after the operation is over. In this case, the shutter blade is transmitted with the trembling to tremble when the shutter blade is opened and closed.

Therefore, each area of the first and second distal ends (251, 252) is larger than each cross-sectional area of the first and second rods (241, 242), whereby scopes of generating the induced electromotive force by the core (200) and the magnet (420) can be evenly distributed if the areas where the electromagnetic force lines are enlarged, and the trembling by the shutter blades (1191, 110b) can be minimized during opening/closing operation.

The first distal end (251) is bent from a distal end of the first rod (241) toward the second rod (242) to face the magnet (420), and an area of the first distal end (251) is larger than a cross-sectional area of the first rod (241).

The first distal end (251) includes an external side (261) positioned at an outside and an internal side (262) positioned at an inside, where a distance (L1) between the external side (261) and the magnet (420) is shorter than a distance (L2) between the internal side (262) and the magnet (420). That is, the distance (L1) between the external side (261) and the magnet (420) is short, while the distance (L2) between the internal side (262) and the magnet (420) is longer than the distance (L 1) between the external side (261) and the magnet (420).

The second distal end (252) is bent from a distal end of the second rod (242) toward the first rod to face a lateral surface of the magnet (420). The second distal end (252) includes a plane unit (263) having an equal distance from the magnet, and an inclination unit (264) having a distance gradually distanced from the magnet (420). That is, the first distal end (252) is formed with a plane unit (263) formed inside and an inclination unit (264) formed outside.

Therefore, each area of the first and second distal ends (251, 252) is larger than each cross-sectional area of the first and second rods (241, 242), whereby a difference between a maximum value and a minimum value of force that acts between the magnet (420) and the core (200) is within 30%.

The core (200) may be formed in a pair about the magnet (420). That is, the core (200) may include a first core (210) facing one lateral surface of the magnet (420), and a second core (220) facing the other lateral surface of the magnet (420). The coil (230) wrapped on the first core (210) and a coil (231) wrapped on the second core (220) are applied with mutually opposite voltages. That is, if a voltage of a forward direction is applied to the coil (230) of the first core (210), the coil (231) of the second core (220) is applied with a voltage of reverse direction. Therefore, the first and second cores (210, 220) are always magnetized with mutually opposite polarities.

For example, if the first distal end (251) of the first core (210) is magnetized with S polarity, a first distal end (253) of the second core (220) is magnetized with N polarity. Alternatively, if a second distal end (252) of the first core (210) is magnetized with N polarity, a second distal end (254) of the second core (220) is magnetized with S polarity.

The magnet (420) is such that one lateral surface facing the first core (210) is so arranged as to have an opposite polarity from that of the other lateral surface facing the second core (220). That is, if the one lateral surface of the magnet (420) is an S pole, the other lateral surface of the magnet (420) is an N pole. The slider (400) is fixed at an upper surface of the magnet (420), and is formed at an upper surface with a driving shaft (410).

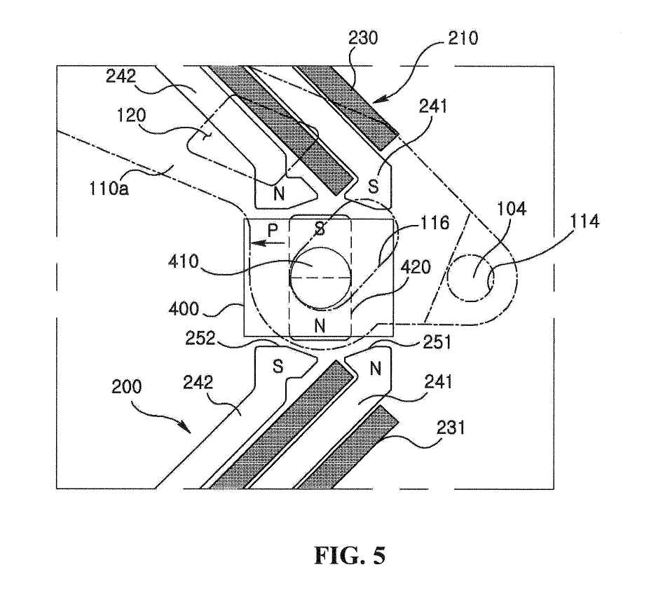

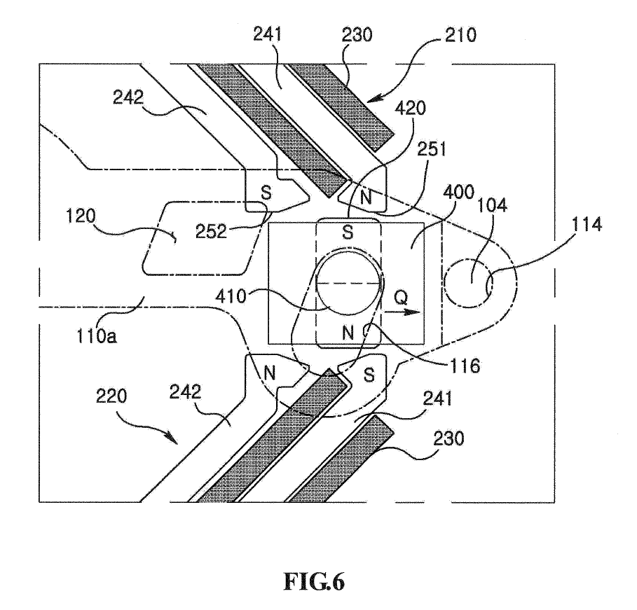

Now, an operation status of a camera shutter device according to an exemplary embodiment of the present disclosure will be described with reference to FIGS. 5 and 6.

FIG. 5 is an operation status view illustrating a camera shutter device that is opened according to an exemplary embodiment of the present disclosure, and FIG. 6 is an operation status view illustrating a camera shutter device that is closed according to an exemplary embodiment of the present disclosure.

Firstly, an opening process of the shutter blades (1101, 10b) will be described.

If a voltage of forward direction is applied to the coil (230) of the first core (210), and a voltage of reverse direction is applied to the coil (231) of the second core (220), the first distal end (251) of the first core (210) is magnetized with S polarity, and the second distal end (252) is magnetized with N polarity. The first distal end (253) of the second core (220) is magnetized with N polarity, and the second distal end (254) is magnetized with S polarity.

Furthermore, a repulsive force is applied to the distal ends (251, 253) due to the fact that one lateral surface of the magnet (420) is S pole, and an attractive force is applied to the second distal ends (252, 254) to move the magnet (420) to an arrow P direction, whereby the driving shaft (410) advances to move along the slot (116) and to open the shutter blades (110q, 110b).

Secondly, a closing process of the shutter blades (1101, 10b) will be described.

A voltage of reverse direction is applied to the coil (230) of the first core (210), and a voltage of forward direction is applied to the coil (231) of the second core (220). Then, the first distal end (251) of the first core (210) is magnetized with N polarity, and the second distal end (252) is magnetized with S polarity. The first distal end (253) of the second core (220) is magnetized with S polarity, and the second distal end (254) is magnetized with N polarity.

Furthermore, an attractive force is applied to the distal ends (251, 253) of the core and the magnet (420), and a repulsive force is applied to the second distal ends (252, 254) and the magnet (420) to move the magnet (420) to an arrow Q direction, whereby the driving shaft (410) is retracted to move along the slot (116) and to close the shutter blades (110q, 110b).

At this time, because each area of the first and second distal ends (251, 252) is larger than each cross-sectional area of the first and second rods (241, 242), an area for generating an electromagnetic force lines can be broadened to evenly distribute a scope of generating the induced electromotive force of the core (200) and the magnet (420), whereby the trembling phenomenon that occurs during opening/closing operation of the shutter blades (110a, 110b) can be minimized.

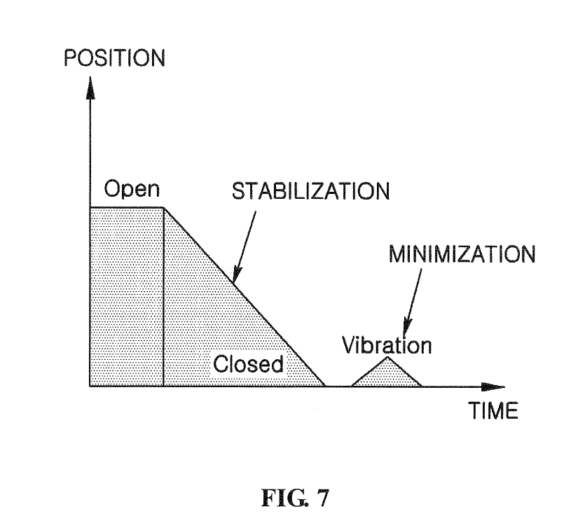

FIG. 7 is a graph illustrating an open/close position of a shutter blade of a camera shutter device according to an exemplary embodiment of the present disclosure.

Referring to FIG. 7, the camera shutter device according to the exemplary embodiment of the present invention can spread a scope of generating the induced electromotive force of the core and the magnet, and reduce a deviation of electromotive force whereby the opening/closing operation of the shutter blades (110a, 110b) can be stabilized, whereby the trembling phenomenon that occurs during opening/closing operation of the shutter blades (110a, 110b) can be minimized.

While the present disclosure has been particularly shown and described with reference to exemplary embodiments thereof, the general inventive concept is not limited to the above-described embodiments. It will be understood by those of ordinary skill in the art that various changes and variations in form and details may be made therein without departing from the spirit and scope of the present invention as defined by the following claims.

### INDUSTRIAL APPLICABILITY

As apparent from the foregoing, the camera shutter device according to the present disclosure has an industrial applicability in that miniaturization and thinning of the shutter device can be realized, and generation of trembling phenomenon can be prevented during an opening/shutting operation of the shutter blade.

What is claimed is:

1. A camera shutter device, the device comprising: a core including a first rod and a second rod, each arranged in parallel with the other, and one of which is wrapped by a coil, a first distal end formed at the first rod to generate an electromagnetic force line, and a second distal end formed at the second rod to generate an electromagnetic force line; a magnet arranged in opposition to the first and second distal ends to linearly and reciprocally move between the first and second distal ends; a slider for opening and closing a shutter blade in a case the magnet linearly and reciprocally moves between the first and second distal ends, wherein each area of the first and second distal ends is larger than each cross-sectional area of the first and second rods.

2. The device of claim 1, wherein the core is fixed at a base and integrally connected by the first and second rods.

3. The device of claim 2, wherein the core is relatively inclined from the magnet at a predetermined angle.

4. The device of claim 1, wherein the first distal end is bent from a distal end of the first rod toward the second rod.

5. The device of claim 1, wherein the first distal end is such that a distance between an external side positioned at an outside and the magnet is shorter than a distance between an internal side positioned at an inside and the magnet.

6. The device of claim 1, wherein the second distal end is bent from a distal end of the second rod toward the first rod.

7. The device of claim 6, wherein the second distal end includes a plane unit distanced from the magnet at a predetermined space, and an inclination unit gradually distanced from the magnet.

8. The device of claim 1, wherein the shutter blade is formed at one side thereof with a hinge hole hinged to the base, and is formed at the other side with a shutter plate for opening and closing an optical permeation hole of the base.

9. The device of claim 8, wherein the shutter blade is formed with a slot into which a driving shaft formed at the slider is inserted.

10. An optical apparatus, the apparatus comprising: a camera including a main body, a display unit arranged at a front surface of the main body for displaying information, and a camera shutter device provided at the main body for capturing an image or a photograph, wherein the camera shutter device includes a core including a first rod and a second rod, each arranged in parallel with the other, and one of which is wrapped by a coil, a first distal end formed at the first rod to generate an electromagnetic force line, and a second distal end formed at the second rod to generate an electromagnetic force line; a magnet arranged in opposition to the first and second distal ends to linearly and reciprocally move between the first and second distal ends; a slider for opening and closing a shutter blade in a case the magnet linearly and reciprocally moves between the first and second distal ends, wherein each area of the first and second distal ends is larger than each cross-sectional area of the first and second rods.

11. The apparatus of claim 10, wherein the core is fixed at a base and integrally connected by the first and second rods.

12. The apparatus of claim 11, wherein the core is relatively inclined from the magnet at a predetermined angle.

13. The apparatus of claim 11, wherein the first distal end is bent from a distal end of the first rod toward the second rod.

14. The apparatus of claim 11, wherein the first distal end is such that a distance between an external side positioned at an outside and the magnet is shorter than a distance between an internal side positioned at an inside and the magnet.

15. The apparatus of claim 11, wherein the second distal end is bent from a distal end of the second rod toward the first rod.

16. The apparatus of claim 15, wherein the second distal end includes a plane unit distanced from the magnet at a predetermined space, and an inclination unit gradually distanced from the magnet.

17. The apparatus of claim 11, wherein the shutter blade is formed at one side thereof with a hinge hole hinged to the base, and is formed at the other side with a shutter plate for opening and closing an optical permeation hole of the base.

18. The apparatus of claim 17, wherein the shutter blade is formed with a slot into which a driving shaft formed at the slider is inserted.
